(19) United States
(12) Patent Application Publication
(10) Pub. No.: US 2026/0109557 A1
(43) Pub. Date: Apr. 23, 2026

(54) LATH PLACER AND METHOD FOR TRANSFERRING LATHS

(71) Applicant: 9051-8127 QUÉBEC INC., Normandin (CA)

(72) Inventors: Gino JOBIN, Normandin (CA); Marc CLOUTIER, Normandin (CA); Jocelyn GAUTHIER, Normandin (CA); Jimmy BELLEMARE, Normandin (CA)

(21) Appl. No.: 19/248,643

(22) Filed: Jun. 25, 2025

Related U.S. Application Data
(60) Provisional application No. 63/709,720, filed on Oct. 21, 2024.

(51) Int. Cl. B65G 57/00; B65G 17/12; B65G 47/06; B65G 47/36; B65G 47/82

(52) U.S. Cl. CPC B65G 57/005; B65G 17/12; B65G 47/06; B65G 47/36; B65G 47/82

(57) ABSTRACT

A lath placer configured to dispose a lath perpendicular and over a row of lumbers comprises a conveyor assembly and a lath-transfer assembly. The conveyor assembly includes at least one lath-supporting lug to move the lath seized at a lath pick-up position. The lath-transfer assembly comprises a unit frame including a transient lath store, a lath-capturing finger movable to capture the lath from one of the at least one lath-supporting lug located at a lath-transferring position and release the lath on the transient lath store, a lath-pushing finger movable to push the lath away from the transient lath store, a rotatable lath-transfer arm including a lath-supporting segment and rotatable between a lath-grasping configuration and a lath-delivering configuration, and a lath-grasping finger movable to grasp the lath located on the lath-supporting segment of the rotatable lath-transfer arm at the lath-grasping configuration and to release the lath at the lath-delivering configuration.

### CROSS-REFERENCE TO RELATED APPLICATIONS

This application claims priority under 35USC§ 119(e) of US provisional patent application 63/709,720 filed Oct. 21, 2024, the specification of which is hereby incorporated by reference.

### TECHNICAL FIELD OF THE INVENTION

The technical field relates to lath (or stick) placers configured to automatically place laths (or sticks) onto a top tier of lumber stack during a stacking cycle. More particularly, it also relates to a lath-transfer unit for the lath placer and to a method for transferring laths from a lath supply to a top tier of lumber stack during a stacking cycle.

### BACKGROUND

Lath placers (also referred to as stick placers) are designed to automatically position laths (or sticks or separators) onto a top of each tier of boards during the piling/stacking phase. A first type of lath placer includes lath magazines located directly at over a lumber bundle and laths are sequentially released from the magazines after a row of lumbers (beams, planks or boards) is added to the bundle. The lath magazines are usually filled manually. A second type of lath placer includes a conveyor and a lath-transfer assembly. The laths are sequentially conveyed by the conveyor above the lumber bundle and are then transferred onto the lumber bundle by the lath-transfer assembly. More particularly, the lath-transfer assembly sequentially transfers each lath directly from the conveyor to the lumber bundle. Once the lath transfer is completed, a subsequent cycle for lath transfer can begin. This limits the lath transfer efficiency because one lath transfer cycle must be completed before beginning a subsequent lath transfer cycle.

In view of the above, there is a need for lath placers which would be able to overcome or at least minimize some of the above-discussed prior art concerns.

### BRIEF SUMMARY OF THE INVENTION

It is therefore an aim of the present invention to address the above-mentioned issues.

According to a general aspect, there is provided a lath placer configured to dispose a lath perpendicular and over a row of lumbers. The lath placer comprises a conveyor assembly and a lath-transfer assembly. The conveyor assembly includes at least one lath-supporting lug to move the lath seized at a lath pick-up position along a lath conveying direction. The lath-transfer assembly is adjacent to the conveyor assembly and includes at least one lath-transfer unit. The at least one lath-transfer unit comprises a unit frame including a transient lath store, a lath-capturing finger movable to capture the lath from a corresponding one of the at least one lath-supporting lug located at a lath-transferring position and release the lath on the transient lath store, a lath-pushing finger movable to push the lath away from the transient lath store, a rotatable lath-transfer arm including a lath-supporting segment configured to receive the lath transferred by the lath-pushing finger, the rotatable lath-transfer arm is rotatable between a lath-grasping configuration and a lath-delivering configuration, and a lath-grasping finger movable to grasp the lath located on the lath-supporting segment of the rotatable lath-transfer arm and to release the lath at the lath-delivering configuration.

In accordance with an embodiment, the lath-transfer assembly is located under the conveyor assembly, the conveyor assembly comprises a conveyor chain with a lower segment, and the lath-transferring position is located on the lower segment of the conveyor chain.

In accordance with an embodiment, the lath-capturing finger is rotatably mounted to the unit frame and rotatable about a lath-capturing finger rotation axis, the lath-capturing finger rotating in a rotation direction corresponding to the lath conveying direction to transfer the lath from the lath-supporting lug to the transient lath store and the transient lath store is located below the corresponding one of the at least one lath-supporting lug at the lath-transferring position.

In accordance with an embodiment, the lath-capturing finger comprises a lath-supporting segment to support the lath during a transfer to the transient lath store and a lath-capturing abutting ridge extending upwardly from the lath-supporting segment, wherein the lath conveyed by the conveyor assembly abuts against the lath-capturing abutting ridge at the lath-transferring position and is transferred onto the lath-supporting segment of the lath-capturing finger.

In accordance with an embodiment, the lath-supporting segment of the lath-capturing finger is substantially aligned with or extends below a lower-facing surface of the lath conveyed by the conveyor assembly.

In accordance with an embodiment, the lath-pushing finger is rotatably mounted to the unit frame and rotatable about a lath-pushing rotation axis between a rearward configuration located behind the lath supported by the transient lath store and a forward configuration located behind the lath supported by the lath-supporting segment of the rotatable lath-transfer arm.

In accordance with an embodiment, the transient lath store extends horizontally and is located rearwardly of and extends continuously with the lath-supporting segment of the lath-transfer arm when the lath-transfer arm is configured in the lath-grasping configuration.

In accordance with an embodiment, the lath-supporting segment of the lath-transfer arm is inclined downwardly when the lath-transfer arm is configured in the lath-grasping configuration.

In accordance with an embodiment, the lath-grasping finger is rotatably mounted to the lath-transfer arm and rotatable about a lath-grasping rotation axis.

In accordance with an embodiment, the lath-grasping finger is located below the transient lath store when the lath-pushing finger transfers the lath from the transient lath store to the lath-supporting segment of the lath-transfer arm, configured in the lath-grasping configuration.

In accordance with an embodiment, the lath-grasping finger comprises a distal prehension end contacting a rearward-facing surface of the lath located on the lath-supporting segment of the lath-transfer arm at the lath-grasping configuration and the lath-transfer arm comprises a lath-transfer abutting ridge contacting a forward facing surface of the lath located on the lath-supporting segment of the lath-transfer arm, the lath being clamped between the distal prehension end of the lath-grasping finger and the lath-transfer abutting ridge of the lath-transfer arm during rotation to the lath-delivering configuration.

In accordance with an embodiment, the lath is released on the row of lumbers at the lath-delivering configuration.

In accordance with an embodiment, the rotatable lath-transfer arm is rotatably mounted to the unit frame and rotates about a lath-transfer rotation axis.

In accordance with an embodiment, the lath-capturing finger, the lath-pushing finger, and the rotatable lath-transfer arm rotates in a same rotation direction to transfer the lath from one location to a subsequent location.

In accordance with an embodiment, rotatable lath-transfer arm rotates of an angle of from 135 to 200 degrees from the lath-grasping configuration to the lath-delivering configuration.

In accordance with an embodiment, the lath-transfer assembly comprises a plurality of lath-transfer unit sets, each one of the sets including at least one of the lath-transfer unit.

In accordance with an embodiment, each one of the sets comprises at least two of the lath-transfer unit, spaced-apart transversally from one another, and wherein the lath-capturing finger, the lath-pushing finger, the rotatable lath-transfer arm, and the lath-grasping finger of a respective one of the sets are synchronized.

In accordance with an embodiment, the lath-pushing finger comprises a plurality of the lath-pushing finger, spaced-apart longitudinally from one another.

According to another general aspect, there is provided a lath placer configured to dispose laths perpendicular and over a row of lumbers. The lath placer comprises a conveyor assembly and a lath transfer assembly. The conveyor assembly includes lath-supporting lugs to convey the laths seized at a lath pick-up position along a lath conveying direction. The lath-transfer assembly is adjacent to the conveyor assembly and comprises a unit frame including a transient lath store, a lath-capturing finger movable to capture the laths from the lath-supporting lugs when located at a lath-transferring position and release the captured laths on the transient lath store, a plurality of lath-pushing fingers, each one of the lath-pushing fingers being movable to push away a respective one of the laths located at the transient lath store, a rotatable lath-transfer arm including a lath-supporting segment configured to receive the respective one of the laths transferred by a respective one of lath-pushing fingers, the rotatable lath-transfer arm is rotatable between a lath-grasping configuration and a lath-delivering configuration, and a lath-grasping finger movable to grasp the respective one of the laths located on the lath-supporting segment of the rotatable lath-transfer arm at the lath-grasping configuration and to release the respective one of the laths at the lath-delivering configuration.

In accordance with an embodiment, the lath-transfer assembly is located under the conveyor assembly, the conveyor assembly comprises a conveyor chain with a lower segment, and the lath-transferring position is located on the lower segment of the conveyor chain.

In accordance with an embodiment, the lath-capturing finger is rotatably mounted to the frame and rotatable about a lath-capturing finger rotation axis, the lath-capturing finger rotating in a rotation direction corresponding to the lath conveying direction to transfer the laths from the lath-supporting lug to the transient lath store and the transient lath store is located below the corresponding one of the at least one lath-supporting lug at the lath-transferring position.

In accordance with an embodiment, the lath-capturing finger comprises a lath-supporting segment to support the captured laths during a transfer to the transient lath store and a lath-capturing abutting ridge extending upwardly from the lath-supporting segment, wherein the laths conveyed by the conveyor assembly abuts against the lath-capturing abutting ridge at the lath-transferring position and is transferred onto the lath-supporting segment of the lath-capturing finger.

In accordance with an embodiment, the lath-supporting segment of the lath-capturing finger is substantially aligned with or extends below a lower-facing surface of the laths conveyed by the conveyor assembly.

In accordance with an embodiment, each of the plurality of lath-pushing fingers is rotatably mounted to the frame and rotatable about a respective of lath-pushing rotation axis to sequentially push the respective one of the laths between a rearward configuration located behind the respective one of the laths supported by the transient lath store and a forward configuration located behind the respective one of the laths supported by the lath-supporting segment of the rotatable lath-transfer arm.

In accordance with an embodiment, the plurality of the lath-pushing fingers are spaced-apart longitudinally along the transient lath store.

In accordance with an embodiment, the transient lath store extends horizontally and is located rearwardly of and extends continuously with the lath-supporting segment of the lath-transfer arm when the lath-transfer arm is configured in the lath-grasping configuration.

In accordance with an embodiment, the lath-supporting segment of the lath-transfer arm is inclined downwardly when the lath-transfer arm is configured in the lath-grasping configuration.

In accordance with an embodiment, the lath-grasping finger is rotatably mounted to the lath-transfer arm and rotatable about a lath-grasping rotation axis.

In accordance with an embodiment, the lath-grasping finger is located below the transient lath store when a downstream one of the plurality of lath-pushing fingers transfers the respective one of the laths from the transient lath store to the lath-supporting segment of the lath-transfer arm, configured in the lath-grasping configuration.

In accordance with an embodiment, the lath-grasping finger comprises a distal prehension end contacting a rearward-facing surface of the respective one of the laths located on the lath-supporting segment of the lath-transfer arm at the lath-grasping configuration and the lath-transfer arm comprises a lath-transfer abutting ridge contacting a forward facing surface of the respective one of the laths located on the lath-supporting segment of the lath-transfer arm, the respective one of the laths being clamped between the distal prehension end of the lath-grasping finger and the lath-transfer abutting ridge of the lath-transfer arm during rotation to the lath-delivering configuration.

In accordance with an embodiment, the respective one of the laths is released on the row of lumbers at the lath-delivering configuration.

In accordance with an embodiment, the rotatable lath-transfer arm is rotatably mounted to the frame and rotates about a lath-transfer rotation axis.

In accordance with an embodiment, the lath-capturing finger, the plurality of lath-pushing fingers, and the rotatable lath-transfer arm rotates in a same rotation direction to transfer the respective one of the laths from one location to a subsequent location.

In accordance with an embodiment, the rotatable lath-transfer arm rotates of an angle of from 135 to 200 degrees from the lath-grasping configuration to the lath-delivering configuration.

In accordance with an embodiment, the lath-transfer assembly comprises a plurality of lath-transfer unit sets, each one of the sets including at least one of the lath-transfer unit.

In accordance with an embodiment, each one of the sets comprises at least two of the lath-transfer unit, spaced-apart transversally from one another, and wherein the lath-capturing finger, the plurality of lath-pushing fingers, the rotatable lath-transfer arm, and the lath-grasping finger of a respective one of the sets are synchronized.

According to still a further general aspect, there is provided a method to dispose a lath perpendicular to and over a row of lumbers with a lath placer. The method comprises conveying the lath along a conveying direction from a lath pick-up position to a lath-transfer assembly; capturing the lath at a lath-transferring position and transferring the lath to a transient lath store; pushing the lath located on the transient lath store onto a lath-supporting segment of a rotatable lath-transfer arm; grasping the lath between the rotatable lath-transfer arm and a lath-grasping finger; rotating the rotatable lath-transfer arm to transfer the lath to a lath-delivering configuration; and releasing the lath at the lath-delivering configuration located above the row of lumbers.

In accordance with an embodiment, the lath-transfer assembly transfers captures and release more than one lath simultaneously over the row of lumbers.

In accordance with an embodiment, the lath is conveyed along the conveying direction with a conveyor assembly including at least one lath-supporting lug, the lath being received and supported by the at least one lath-supporting lug.

According to a general aspect, there is provided a lath placer configured to dispose a lath perpendicular to and over a row of lumbers. The lath placer comprises a conveyor assembly and a lath-transfer assembly. The conveyor assembly includes at least one lath-supporting lug to move the lath seized at a lath pick-up position along a lath conveying direction. The lath-transfer assembly is adjacent to the conveyor assembly and includes at least one lath-transfer unit that comprises a unit frame, a lath-capturing finger, a lath-pushing finger, a rotatable lath-transfer arm and a lath-grasping finger. The unit frame includes a transient lath store. The lath-capturing finger is movable to capture the lath from a corresponding one of the at least one lath-supporting lug located at a lath-transferring position and release the lath on the transient lath store. The lath-pushing finger is movable to push the lath away from the transient lath store. The rotatable lath-transfer arm includes a lath-supporting segment configured to receive the lath transferred by the lath-pushing finger. The rotatable lath-transfer arm is rotatable between a lath-grasping configuration and a lath-delivering configuration. The lath-grasping finger is movable to grasp the lath located on the lath-supporting segment of the rotatable lath-transfer arm at the lath-grasping configuration and to release the lath at the lath-delivering configuration.

In accordance with an embodiment, the lath-capturing finger is rotatably mounted to the unit frame and is rotatable about a lath-capturing finger rotation axis. The lath-capturing finger is rotating in a rotation direction corresponding to the lath conveying direction to transfer the lath from the lath-supporting lug to the transient lath store and the transient lath store is located below the corresponding one of the at least one lath-supporting lug at the lath-transferring position.

In accordance with an embodiment, the lath-capturing finger comprises a lath-supporting segment to support the lath during a transfer to the transient lath store and a lath-capturing abutting ridge extending upwardly from the lath-supporting segment. The lath conveyed by the conveyor assembly abuts against the lath-capturing abutting ridge at a lath-capturing configuration and is transferred onto the lath-supporting segment of the lath-capturing finger.

In accordance with an embodiment, the lath-transfer assembly is located under the conveyor assembly and the conveyor assembly comprises a conveyor chain with a lower segment. The lath-transferring position is located on the lower segment of the conveyor chain and the lath-supporting segment of the lath-capturing finger is substantially aligned with or extends below a lower-facing surface of the lath conveyed by the conveyor assembly.

In accordance with an embodiment, the lath-pushing finger is rotatably mounted to the unit frame and is rotatable about a lath-pushing rotation axis between a rearward configuration located behind the lath supported by the transient lath store and a forward configuration located behind the lath supported by the lath-supporting segment of the rotatable lath-transfer arm.

In accordance with an embodiment, the transient lath store extends horizontally and is located rearwardly of and extends continuously with the lath-supporting segment of the rotatable lath-transfer arm when the rotatable lath-transfer arm is configured in the lath-grasping configuration.

In accordance with an embodiment, the lath-grasping finger is rotatably mounted to the rotatable lath-transfer arm and is rotatable about a lath-grasping rotation axis. The lath-grasping finger is located below the transient lath store when the lath-pushing finger transfers the lath from the transient lath store to the lath-supporting segment of the rotatable lath-transfer arm, configured in the lath-grasping configuration.

In accordance with an embodiment, the lath-grasping finger comprises a prehension end contacting a rearward-facing surface of the lath located on the lath-supporting segment of the rotatable lath-transfer arm at the lath-grasping configuration and the rotatable lath-transfer arm comprises a lath-transfer abutting ridge contacting a forward facing surface of the lath located on the lath-supporting segment of the rotatable lath-transfer arm. The lath is being clamped between the prehension end of the lath-grasping finger and the lath-transfer abutting ridge of the rotatable lath-transfer arm during rotation to the lath-delivering configuration.

In accordance with an embodiment, the lath-capturing finger, the lath-pushing finger, and the rotatable lath-transfer arm rotates in a same rotation direction to transfer the lath from one location to a subsequent location and the rotatable lath-transfer arm rotates of an angle of from 135 to 200 degrees from the lath-grasping configuration to the lath-delivering configuration.

In accordance with an embodiment, the lath-transfer assembly comprises a plurality of lath-transfer unit sets, each one of the sets including at least one of the lath-transfer unit. Each one of the sets comprises at least two of the lath-transfer unit, spaced-apart transversally from one another. The lath-capturing finger, the lath-pushing finger, the rotatable lath-transfer arm, and the lath-grasping finger of a respective one of the sets are synchronized and the lath is released on the row of lumbers.

According to another general aspect, there is provided a lath placer configured to dispose laths perpendicular and over a row of lumbers. The lath placer comprises a conveyor assembly and a lath-transfer assembly. The conveyor assembly includes lath-supporting lugs to convey the laths seized at a lath pick-up position along a lath conveying direction. The lath-transfer assembly is adjacent to the conveyor assembly and comprises a unit frame, a lath-capturing finger, a plurality of lath-pushing fingers, a rotatable lath-transfer arm and a lath-grasping finger. The unit frame includes a transient lath store. The lath-capturing finger is movable to capture the laths from the lath-supporting lugs when located at a lath-transferring position and release the captured laths on the transient lath store. Each one of the lath-pushing fingers is movable to push away a respective one of the laths located at the transient lath store. The rotatable lath-transfer arm includes a lath-supporting segment configured to receive the respective one of the laths transferred by a respective one of lath-pushing fingers. The rotatable lath-transfer arm is rotatable between a lath-grasping configuration and a lath-delivering configuration. The lath-grasping finger is movable to grasp the respective one of the laths located on the lath-supporting segment of the rotatable lath-transfer arm at the lath-grasping configuration and to release the respective one of the laths at the lath-delivering configuration.

In accordance with an embodiment, the lath-capturing finger is rotatably mounted to the unit frame and rotatable about a lath-capturing finger rotation axis. The lath-capturing finger is rotating in a rotation direction corresponding to the lath conveying direction to transfer the laths from one of the lath-supporting lugs to the transient lath store and the transient lath store is located below the corresponding one of the lath-supporting lugs at the lath-transferring position.

In accordance with an embodiment, the lath-capturing finger comprises a lath-supporting segment to support the captured laths during a transfer to the transient lath store and a lath-capturing abutting ridge extending upwardly from the lath-supporting segment. The laths conveyed by the conveyor assembly abut against the lath-capturing abutting ridge at the lath-transferring position and are transferred onto the lath-supporting segment of the lath-capturing finger.

In accordance with an embodiment, each of the plurality of lath-pushing fingers is rotatably mounted to the unit frame and rotatable about a respective of lath-pushing rotation axis to sequentially push the respective one of the laths between a rearward configuration located behind the respective one of the laths supported by the transient lath store and a forward configuration located behind the respective one of the laths supported by the lath-supporting segment of the rotatable lath-transfer arm.

In accordance with an embodiment, the transient lath store extends horizontally and is located rearwardly of and extends continuously with the lath-supporting segment of the rotatable lath-transfer arm when the rotatable lath-transfer arm is configured in the lath-grasping configuration.

In accordance with an embodiment, the lath-grasping finger is located below the transient lath store when a downstream one of the plurality of lath-pushing fingers transfers the respective one of the laths from the transient lath store to the lath-supporting segment of the rotatable lath-transfer arm, configured in the lath-grasping configuration.

In accordance with an embodiment, the lath-grasping finger comprises a prehension end contacting a rearward-facing surface of the respective one of the laths located on the lath-supporting segment of the rotatable lath-transfer arm at the lath-grasping configuration and the rotatable lath-transfer arm comprises a lath-transfer abutting ridge contacting a forward facing surface of the respective one of the laths located on the lath-supporting segment of the rotatable lath-transfer arm. The respective one of the laths is being clamped between the prehension end of the lath-grasping finger and the lath-transfer abutting ridge of the rotatable lath-transfer arm during rotation to the lath-delivering configuration.

In accordance with an embodiment, the lath-transfer assembly comprises a plurality of lath-transfer unit sets, each one of the sets including at least one lath-transfer unit. The lath-capturing finger, the plurality of lath-pushing fingers, and the rotatable lath-transfer arm rotates in a same rotation direction to transfer the respective one of the laths from one location to a subsequent location.

According to still another general aspect, there is provided a method to dispose a lath perpendicular to and over a row of lumbers with a lath placer. The method comprises: conveying the lath along a conveying direction from a lath pick-up position to a lath-transfer assembly; capturing the lath at a lath-transferring position and transferring the lath to a transient lath store; pushing the lath located on the transient lath store onto a lath-supporting segment of a rotatable lath-transfer arm; grasping the lath between the rotatable lath-transfer arm and a lath-grasping finger; rotating the rotatable lath-transfer arm to transfer the lath to a lath-delivering configuration; and releasing the lath at the lath-delivering configuration located above the row of lumbers.

In accordance with an embodiment, the lath-transfer assembly transfers captures and release more than one lath simultaneously over the row of lumbers.

### BRIEF DESCRIPTION OF THE DRAWINGS

FIG. 1 is a side elevation view of a lath placer in accordance with an embodiment.

FIG. 2 is a top elevation view of the lath placer of FIG. 1.

FIG. 3 is a perspective view of a set of lath-transfer units of the lath placer of FIG. 1, in accordance with an embodiment.

FIG. 4 is a side elevation view of one of the lath-transfer unit of FIG. 3.

FIG. 5 is a side elevation view of the lath transfer unit of FIG. 4 in combination with a section of a conveyor of the lath placer, wherein a first lath is conveyed by a first lath-transfer lug of the conveyor.

FIG. 6 is a side elevation view of the lath transfer unit in combination with the section of the conveyor of FIG. 5, wherein the first lath, conveyed by the first lath-transfer lug, has been captured by a lath-capturing finger of the lath transfer unit.

FIG. 7 is a side elevation view of the transfer unit in combination with the section of the conveyor of FIG. 5, wherein the first lath, captured by the lath-capturing finger, is transferred to a transient lath store of the lath transfer unit and a second lath is conveyed by a second lath-transfer lug.

FIG. 8 is a side elevation view of the lath transfer unit in combination with the section of the conveyor of FIG. 5, wherein the first lath is located in the transient lath store.

FIG. 9 is a side elevation view of the lath transfer unit in combination with the section of the conveyor of FIG. 5, wherein the first lath is pushed by a lath-pushing finger of the lath transfer unit from the transient lath store onto a rotatable lath-transfer arm of the lath transfer unit.

FIG. 10 is a side elevation view of the lath transfer unit in combination with the section of the conveyor of FIG. 5, wherein the first lath, located on the rotatable lath-transfer arm, is clasped between a lath-grasping finger of the lath transfer unit and a section of the rotatable lath-transfer arm and the second lath, conveyed by the second lath-transfer lug, has been captured by the lath-capturing finger.

FIG. 11 is a side elevation view of the lath transfer unit in combination with the section of the conveyor of FIG. 5, wherein the rotatable lath-transfer arm has rotated to a lath-delivering configuration.

FIG. 12 is a side elevation view of the lath transfer unit in combination with the section of the conveyor of FIG. 5, wherein the first lath has been released onto a top tier of a lumber bundle and the second lath, captured by the lath-capturing finger, is transferred to the transient lath store.

FIG. 13 is a side elevation view of a section of a lath placer in accordance with a second embodiment, wherein the transient lath store and the lath transfer unit includes three lath-pushing fingers and a first lath is being conveyed by a first lath-transfer lug.

FIG. 14 is a side elevation view of the section of the lath placer of FIG. 13, wherein the first lath, conveyed by the first lath-transfer lug, has been captured by the lath-capturing finger.

FIG. 15 is a side elevation view of the section of the lath placer of FIG. 13, wherein the first lath, captured by the lath-capturing finger, is transferred to the transient lath store.

FIG. 16 is a side elevation view of the section of the lath placer of FIG. 13, wherein the first lath located on the transient lath store has been pushed by a first one of the lath-pushing fingers towards a second one of the lath-pushing fingers.

FIG. 17 is a side elevation view of the section of the lath placer of FIG. 13, wherein a second lath, conveyed by a second lath-transfer lug, has been captured by the lath-capturing finger.

FIG. 18 is a side elevation view of the section of the lath placer of FIG. 13, wherein the first lath located on the transient lath store has been pushed by the second one of the lath-pushing fingers towards a third one of the lath-pushing fingers and the second lath is transferred onto the transient lath store by the lath-capturing finger.

FIG. 19 is a side elevation view of the section of the lath placer of FIG. 13, wherein the first lath has been pushed by the third one of the lath-pushing fingers onto the rotatable lath transfer arm and clasped with the lath-grasping finger, the second one of the lath has been pushed by the first one of the lath-pushing fingers towards the second one of the lath-pushing fingers, and a third one of the laths is conveyed by a subsequent lath-transfer lug.

FIG. 20 is a side elevation view of the section of the lath placer of FIG. 13, wherein the rotatable lath-transfer arm, with the first lath clamped, has rotated to the lath-delivering configuration, the second lath is still located on the transient lath store, and the third lath is transferred onto the transient lath store by the lath-capturing finger.

It will be noted that throughout the appended drawings, like features are identified by like reference numerals.

### DETAILED DESCRIPTION

Moreover, although the embodiments of the lath placer, the lath transfer unit, and corresponding parts thereof consist of certain geometrical configurations as explained and illustrated herein, not all of these components and geometries are essential and thus should not be taken in their restrictive sense. It is to be understood, as also apparent to a person skilled in the art, that other suitable components and cooperation thereinbetween, as well as other suitable geometrical configurations, may be used for the lath placer, as will be briefly explained herein and as can be easily inferred herefrom by a person skilled in the art. Moreover, it will be appreciated that positional descriptions such as “above”, “below”, “left”, “right” and the like should, unless otherwise indicated, be taken in the context of the figures and correspond to the position and orientation of the path placer. They should not be considered limiting. For instance, the term “above” correspond to a position closer to the conveyor and the term “below”, to a position closer a lath bundle.

In the following description, the same numerical references refer to similar elements. Furthermore, for the sake of simplicity and clarity, namely so as to not unduly burden the figures with several references numbers, not all figures contain references to all the components and features, and references to some components and features may be found in only one figure, and components and features of the present disclosure which are illustrated in other figures can be easily inferred therefrom. The embodiments, geometrical configurations, materials mentioned and/or dimensions shown in the figures are optional, and are given for exemplification purposes only.

To provide a more concise description, some of the quantitative expressions given herein may be qualified with the term “about”. It is understood that whether the term “about” is used explicitly or not, every quantity given herein is meant to refer to an actual given value, and it is also meant to refer to the approximation to such given value that would reasonably be inferred based on the ordinary skill in the art, including approximations due to the experimental and/or measurement conditions for such given value.

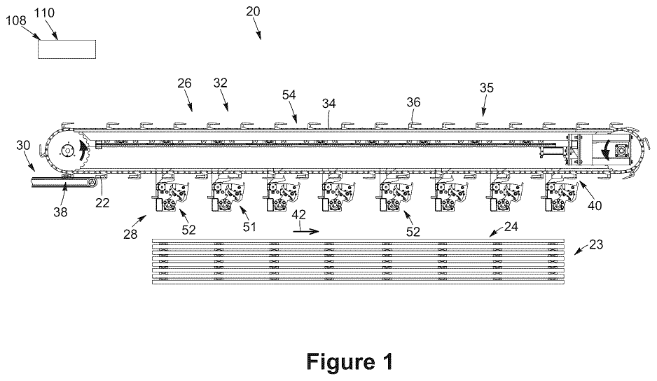

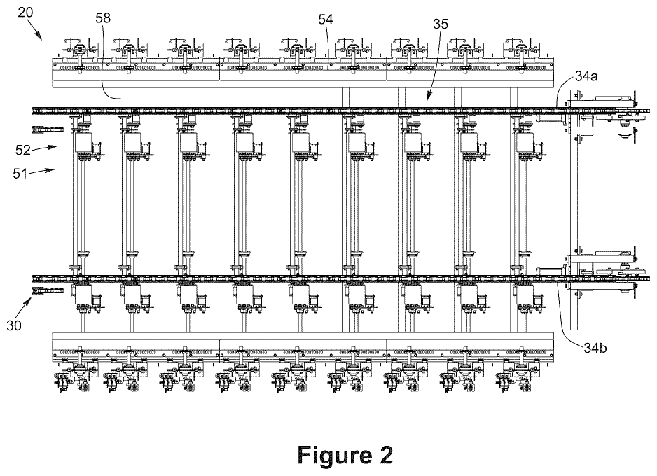

Referring to FIGS. 1 and 2, there is shown a non-limitative embodiment of a lath placer 20. The lath placer 20 is configured to dispose laths 22 (also referred to as sticks or separators) onto an upper surface of a row of lumbers 24 and, more particularly, a top tier 24 of a lumber bundle 23. The lath placer 22 includes a conveyor assembly 26 and a lath-transfer assembly 28. The laths 22 are sequentially supplied to the conveyor assembly 26 of the lath placer 20 from a loading station 30 (only a portion is shown in FIG. 1). While conveyed in a lath-conveying direction 42 along the conveyor assembly 26, the laths 22 are seized by the lath-transfer assembly 28. The lath-transfer assembly 28, in turn, sequentially transfers the laths 22 on the topmost tier 24 of a lumber bundle 23.

The conveyor assembly 26 also includes a conveyor 32, which is embodied, in the non-limitative embodiment shown, by two transversally spaced-apart conveyor chains 34. Hereinafter, the terms “transversal” “transversally” are intended to mean perpendicular to the lath-conveying direction 42 of the conveyor 32. The lath-conveying direction 42 represents a direction of motion of the laths 22 between the loading station 30 and the lath-transfer assembly 28. For example and without being limitative, in the embodiment shown, the lath-conveying direction 42 corresponds to the direction from left to right in FIG. 1. It is understood that even if the conveyor 32 completes a loop (e.g., in the counter-clockwise direction in the embodiment shown), the lath-conveying direction corresponds to only a portion of the loop and, more particularly, the lower portion in the non-limitative embodiment shown. Each one of the conveyor chains 34 has a plurality of lath-supporting lugs 36 mounted thereto. The lath-supporting lugs 36 of the conveyor chains 34 are aligned in a manner such that the laths 22 can be supported, along their length, by two transversally spaced-apart lath-supporting lugs 36 (forming a set of lath-supporting lugs 36). The laths 22 are fed separately/individually to the conveyor assembly 26 from the loading station 30. As mentioned above, in the embodiment shown, the conveyor 32 includes two conveyor chains 34a, 34b (FIG. 2). It is appreciated that, in an alternative embodiment (not shown), the conveyor 32 can differ from the embodiment shown. For instance, the conveyor 32 can include a set of conveyor chains 34 including more than two conveyor chains 34a, 34b, each one including lath-supporting lugs 36. It is appreciated that the conveyor chains can be replaced or combined with any other suitable conveyor devices such as and without being limitative conveyor belts.

Each one of the lath-supporting lugs 36 is designed to hold and transport at least one lath 22 along the lath-conveying direction 42. The laths 22, located at the loading station 30, are sequentially loaded on a respective one of the sets 35 of the lath-supporting lugs 36 located at a lath pick-up position 38, adjacent to a first end of the conveyor 32 and on a lower segment 40 thereof. As the conveyor chains 34 rotates continuously, the set 35 of lath-supporting lugs 36, each loaded with at least one lath 22, are conveyed along the lath-conveying direction 42.

In the embodiment shown in FIGS. 1 and 5 to 12, each one of the lath-supporting lugs 36 is substantially L-shaped with a lath-abutting segment 46 and a lath-supporting segment 50, the lath-abutting segment 46 being located forwardly and the lath-supporting lug 36 being opened rearwardly, with respect to the lath-conveying direction 42. The lath-supporting lugs 36 extend outwardly from loops of the conveyor chains 34. Therefore, when carried on the lower segment 40, the lath-supporting lugs 36 extend downwardly, i.e. towards the lath-transfer assembly 28. In the embodiment shown in FIG. 1, several lath-supporting lugs 36 transport one lath 22. A forward-facing surface 44 of the lath 22 is abutting (or adjacent to) the lath-abutting segment 46 of the lath-supporting lug 36. The lath 22 is supported by the lath-supporting segment 50, with a lower-facing surface 48 of the lath 22 contacting the lath-supporting segment 50. It is appreciated that, in another embodiment (not shown), the lath-supporting lugs 36 can have a different shape and hold a different number of laths 22.

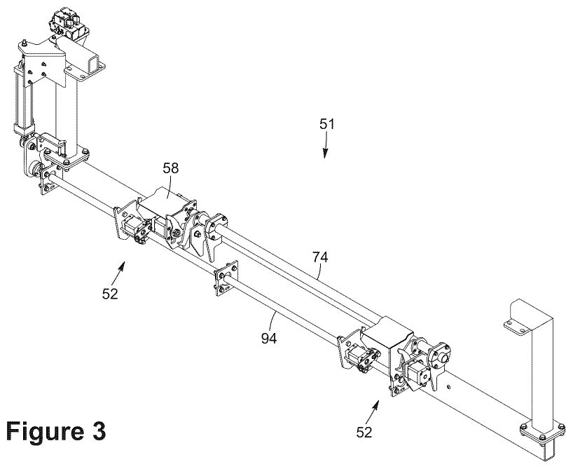

In the non-limitative embodiment shown, the lath-transfer assembly 28 includes a plurality of lath-transfer units 52, provided in longitudinally spaced-apart sets 51, as shown in FIGS. 2 and 3. In the non-limitative embodiment shown, each one of the sets 51 of lath-transfer units 52 is a pair of transversally spaced-apart lath-transfer units 52, i.e., one lath-transfer unit 52 associated to each one of the conveyor chains 34a, 34b. The sets 51 of lath-transfer units 52 are longitudinally spaced-apart from one another, i.e., spaced-apart along the lath-conveying direction 42. In the non-limitative embodiment shown, each one of the sets 51 of lath-transfer units 52 is configured to capture one lath 22 carried by the conveyor 32 and transfer the captured lath onto the topmost tier 24 of a lumber bundle 23, as shown in FIG. 1. As the sets of lath-transfer units 51 are longitudinally spaced-apart, the laths 22 released onto the topmost tier of a lumber bundle 23 are also spaced-apart along a longitudinal axis of the lumbers defining the topmost tier 24. In the non-limitative embodiment shown, the lath-transfer units 52 are mounted inbetween the two conveyor chains 34a, 34b. In the embodiment shown, the lath-transfer assembly 28 extends mostly below the lower segment 40 of the conveyor 32. In another embodiment (not shown), the lath-transfer units 52 can be mounted outwardly of the conveyor chains or in a combination of outwardly/inwardly thereof.

It is appreciated that the number and the configuration of the lath-transfer units 52 of the lath-transfer assembly 28 and the number of lath-transfer units 52 per set can vary from the embodiment shown.

As shown in FIGS. 1 to 4 and 6, each one of sets 51 of lath-transfer units 52 includes a unit frame 58 and the lath-transfer units 52 of the set 51 are mounted on a main frame 54. Each lath 22 is conveyed on the conveyor 32 up to a lath-transferring position 37, i.e., a location along the lower segment 40 of the conveyor 32 wherein one lath 22 conveyed by a set of lath-supporting lugs 36 of the conveyor 32 is transferred to the respective set 51 of lath-transfer units 52. In other words, it is understood that there is one lath-transferring position 37 for each set 51 of lath-transfer units 52 and the lath-transfer assembly 28 can comprises a plurality of lath-transferring positions 37. Furthermore, a lath-transferring position 37 can be associated with each one of the sets of lath-supporting lugs 36 and several sets of lath-supporting lugs 36 can have the same lath-transferring position 37.

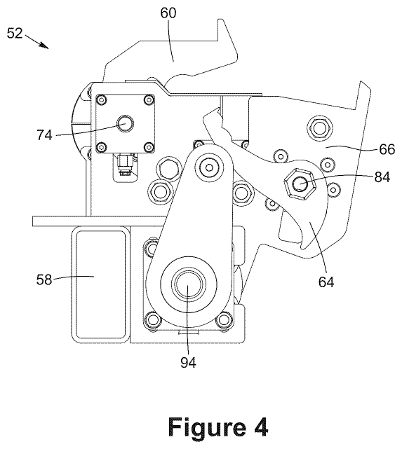

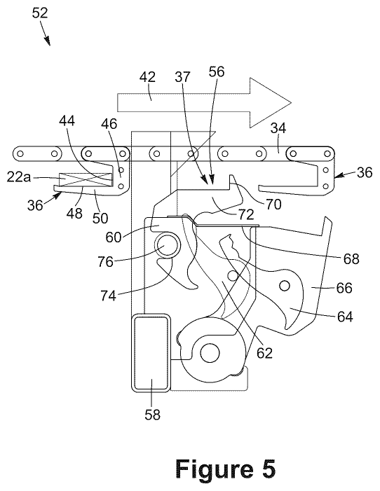

Referring now to FIGS. 1 to 3, each set of lath-transfer unit 51 includes the unit frame 58, mounted to the main frame 54 (see FIG. 2) and extends transversally, i.e. normal to the lath-conveying direction 42. Turning now to FIGS. 4 and 5, each lath-transfer unit 52 includes a lath-capturing finger 60, a lath-pushing finger 62, a lath-grasping finger 64, and a rotatable lath-transfer arm 66.

The next paragraphs describe how a respective lath 22 is captured from the conveyor 32 and moved across a respective set 51 of lath-transfer units 52. In order to simplify the description hereafter, only one lath-transfer unit 52 is described, although it is understood that the lath-transfer units 52 of the set 51 are essentially identical and operate concurrently. The sets 51 of lath-transfer units 52 are also essentially identical. Thus, the following paragraphs apply to all lath-transfer units 52 of the lath-transfer assembly 28.

Referring to FIGS. 5 to 12, the unit frame 58 includes a transient lath store 68 where at least one lath 22, captured from the conveyor 32, can be stored before being transferred to the topmost tier 24 of the lumber bundle 23. In the non-limitative embodiment shown, the transient lath store 68 includes a flat surface of the unit frame 58 configured for receiving the lower-facing surface 48 of the lath 22. Additional information about the transient lath store 68 will be provided in the paragraphs below.

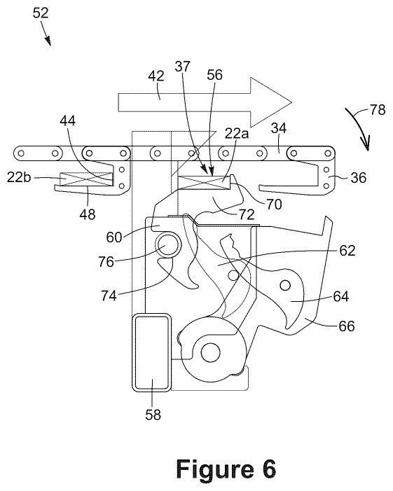

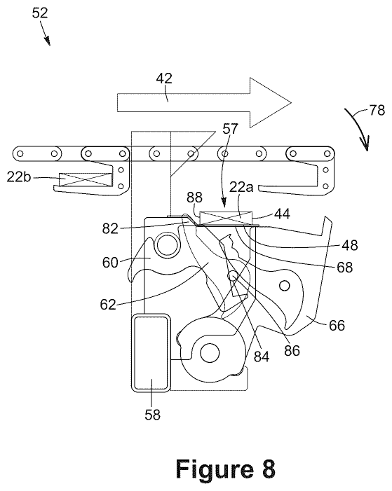

Referring more specifically to FIGS. 5 to 8 showing one of the lath-transfer units 52, there is shown that the lath-capturing finger 60 is pivotally mounted to the unit frame 58, more specifically in an upper portion thereof. More particularly, the set 51 of lath-transfer units 52 includes a lath-capturing finger shaft 74 (see FIGS. 2 and 3) extending transversally between the lath-transfer units 52 of the set 51. The lath-capturing finger shaft 74 is rotatably mounted to the unit frames 58 of a respective set 51 of lath-transfer units 52. The lath-capturing fingers 60 of the set 51 are secured to the lath-capturing finger shaft 74 and rotates simultaneously therewith. Therefore, the lath-capturing fingers 60 of the set 51 are synchronized in their pivoting movement. They pivot between a lath-capturing configuration 56 (FIG. 6), wherein the lath 22 carried by the lath-supporting lugs 36 of one of the sets is captured, to a lath-releasing configuration 57 (FIG. 8).

In the embodiment shown, in the lath-capturing configuration 56, each lath-capturing finger 60 is substantially at a same location as the respective one of the lath-transferring positions 37, for a respective set of lath-supporting lugs 36. It is understood that, in another embodiment not shown, in the lath-capturing configuration 56, the lath-capturing finger 64 can be further spaced-apart from the lath-transferring position 37. For example, the lath-capturing configuration 56 can be located further below the lath-transferring position 37.

The lath-capturing finger 60 has a lath-supporting segment 72 and a lath-capturing abutting ridge 70 extending upwardly from the lath-supporting segment 72 at an end thereof, in the lath-capturing configuration 56. Together, the lath-capturing abutting ridge 70 and the lath-supporting segment 72 form an L-shaped profile.

When a first lath 22a, conveyed by the conveyor 32 in the lath-conveying direction 42, reaches its respective lath-transferring position 37, the lath-capturing finger 60 is already configured in the lath-capturing configuration 56 and the forward-facing surface 44 of the lath 22a abuts against the lath-capturing abutting ridge 70 of the lath-capturing finger 60, preventing the lath 22a from being conveyed further away in the lath-conveying direction 42. The lath-supporting lugs 36 being open rearwardly, the lath 22a transfers onto the lath-supporting segment 72 of the lath-capturing finger 60, while the lath-supporting lugs 36 continue their path in the lath-conveying direction 42. The lower-facing surface 48 of the lath 22a thus contacts the lath-supporting segment 72 of the lath-capturing finger 60. When a rotation path of the lath-capturing finger 60 is cleared from the lath-supporting lugs 36, the lath-capturing finger 60 rotates towards the lath-releasing configuration 57, e.g., clockwise in the non-limitative embodiment shown. A direction of displacement (e.g. rotation) of the lath-capturing finger 60 from the lath-capturing configuration 56 to the lath-releasing configuration 57 can be substantially in a same direction than the lath-conveying direction 42.

The lath-capturing fingers 60 of the set 51 rotate about a lath-capturing finger rotation axis 76 aligned with the lath-capturing finger shaft 74. The lath-capturing finger shaft 74 is engaged in rotation by a motor (not shown) operatively connected thereto. The motor can be an electric motor like a servomotor, a DC motor, a stepper motor or a brushless motor. In another embodiment not shown, the actuation of the lath-capturing finger 60 can be made by a hydraulic system, a pneumatic system or another type of actuation mechanism. Even though the displacement of the lath-capturing finger shaft 74 is referred to as a rotation, the lath-capturing finger shaft 74 pivots between two configurations: the lath-capturing configuration 56 (FIG. 6) and the lath-releasing configuration 57 (FIG. 8).

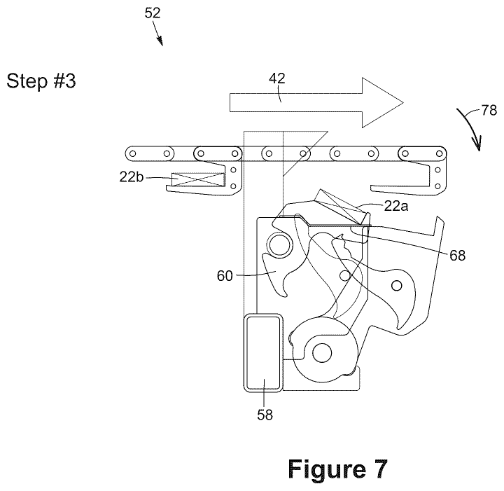

Once the first lath 22a is captured by the lath-capturing finger 60 (i.e., free from the lath-supporting lug 36), the lath-capturing finger shaft 74 is actuated and rotates in a first rotation direction 78 (FIG. 7) (clockwise in the non-limitative embodiment shown), engaging simultaneously the lath-capturing finger 60 in rotation, towards the lath-releasing configuration 57. A tangential vector of the first rotation direction 78 is the same direction as the lath-conveying direction 42. Along the rotation path of the lath-capturing finger shaft 74, the lath 22a, supported by the lath-supporting segment 72 of the lath-capturing finger 60, contacts the transient lath store 68 and is released thereon, while the lath-capturing finger 60 continues its rotation path towards the lath-releasing configuration 57. In the embodiment shown, the lower-facing surface 48 of the lath 22a contacts the transient lath store 68. In the lath-releasing configuration 57 (FIG. 8), the lath-capturing finger shaft 74 is located below the transient lath store 68.

Even though the displacement of the lath-capturing finger 60 from the lath-capturing configuration 56 (FIG. 6) to the lath-releasing configuration 57 (FIG. 8) is embodied by a rotation movement, it is appreciated that, in an alternative embodiment, the displacement of the lath-capturing finger 60 can differ. For instance and without being limitative, in another embodiment (not shown), the lath-capturing finger 60 can move along a translation axis, therefore being displaced by translation instead of rotation. In still another embodiment, the lath-capturing finger 60 can be displaced along a trajectory that is a combination of a rotation and a translation.

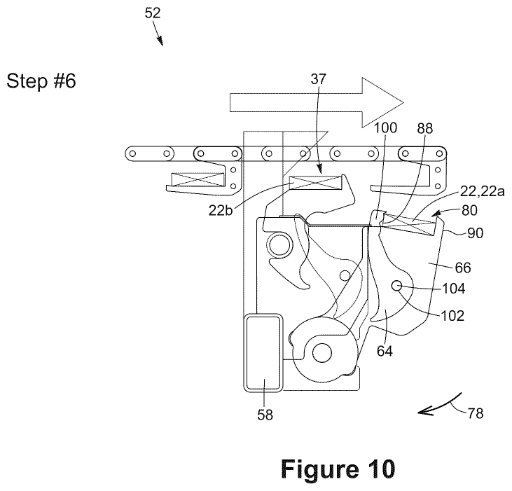

In the embodiment shown, the lath-capturing finger 60 is returned to the lath-capturing configuration 56 once the first lath 22a is removed from the transient lath store 68 (FIG. 10). The lath-capturing finger 60 via a rotation of the lath-capturing finger shaft 74 in a second rotation direction, opposed to the first rotation direction 78 (counter-clockwise in the non-limitative embodiment shown). Once the first lath 22a is removed from the capturing-finger shaft 74, a range of motion of the lath-capturing finger 60 is clear from the first lath 22a.

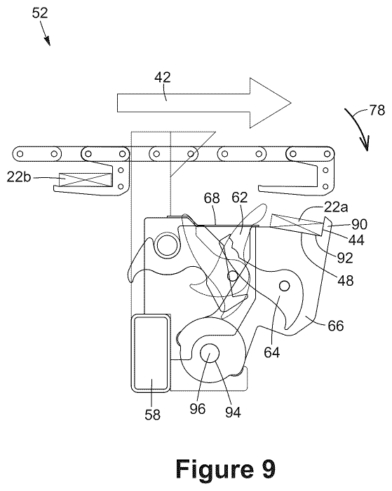

Turning now to FIGS. 8 and 9, the first lath 22a is transferred from the transient lath store 68 to a lath-grasping configuration 80 (FIG. 10) by the lath-pushing finger 62. The lath-pushing finger 62 is mounted to the unit frame 58 and, more particularly, rotatably mounted thereto. In the non-limitative embodiment shown, a lath-pushing finger rotation axis 86 of the lath-pushing finger 62 is located below the lath-capturing finger rotation axis 76 (FIGS. 5 and 6).

In the embodiment shown, the first lath 22a is pushed by the lath-pushing finger 62, more specifically by a lath-pushing fingertip 82 located at a free end of the lath-pushing finger 62. The lath-pushing fingertip 82 contacts the lath 22 on a rearward-facing surface 88 thereon, opposed to the forward-facing surface 44. While being pushed rearwardly, the first lath 22a slides across the transient lath store 68. In the non-limitative embodiment shown, the lath 22 is pushed until it is removed from the transient lath store 68 and, more specifically, entirely transferred onto the rotatable lath-transfer arm 66, as described in further detail below. It is appreciated that the lath 22 can be pushed away from the transient lath store 68 using another section of the lath-pushing finger 62.

In the embodiment shown, the lath-pushing finger 62 is rotatable in the first rotation direction 78, i.e. in the same rotation direction as the lath-capturing finger 60 to transfer the first lath 22a. The lath-pushing finger 62 is mounted to the lath-pushing finger shaft 84, which, in turn, is mounted to the unit frame 58. Engagement of the lath-pushing finger shaft 84 in a rotation direction simultaneously engage the lath-pushing finger 62 in rotation. The lath-pushing finger shaft 84 is actuated by a motor operatively connected thereto. The motor can be an electric motor, like a servomotor, a DC motor, a stepper motor or a brushless motor. In another embodiment (not shown), the actuator of the lath-pushing finger 62 can be a hydraulic system, a pneumatic system or another type of actuation mechanism.

Even though the displacement of the lath-pushing finger 62 from a rearward configuration (or starting configuration) (FIG. 8) to a forward configuration (or end configuration) (FIG. 9) is embodied by a rotation movement, it is appreciated that, in an alternative embodiment, the displacement of the lath-pushing finger 62 can differ. For instance and without being limitative, in another embodiment (not shown), the lath-pushing finger 62 can move along a translation axis, therefore being displaced by translation instead of rotation. The translation axis can be parallel to the transient lath store 68. In still another embodiment, the lath-pushing finger 62 can be displaced along a trajectory that is a combination of a rotation and a translation.

Even though the displacement of the lath-pushing finger 62 is referred to as a rotation, the lath-pushing finger 62 pivots between two configurations: the rearward configuration (FIG. 8) and the forward configuration (FIG. 9).

In the embodiment shown, the lath-pushing finger 62 is returned to its rearward configuration once the lath 22 is entirely transferred to the rotatable lath-transfer arm 66. In another embodiment (not shown), the lath-pushing finger 62 can complete a full rotation about the lath-pushing finger rotation axis 86.

Referring now to FIGS. 9 to 12, the rotatable lath-transfer arm 66, configured to transfer and release the first lath 22a onto the topmost tier 24 of the lumber bundle 23, will be described in further detail. The rotatable lath-transfer arm 66 is mounted to the unit frame 58. In the non-limitative embodiment shown, a lath-transfer arm shaft 94 operatively engaged with the rotatable lath-transfer arm 66 is located below the transient lath store 68 and below the shafts 74, 84 of the lath-capturing finger 60 and the lath-pushing finger 62.

The rotatable lath-transfer arm 66 has a lath-supporting segment 92 to receive and support transfer from the transient lath store 68 and a lath-transfer abutting ridge 90 extending upwardly from a free end of the lath-supporting segment 92, in the lath-grasping configuration 80, and substantially perpendicular thereto. The lath-transfer abutting ridge 90 and the lath-supporting segment 92 define an L-shaped end of the rotatable lath-transfer arm 66, which is similar in shape to an end of the lath-capturing finger 60.

When the lath-pushing finger 62 transfers the first lath 22a onto the lath-supporting segment 92 of the rotatable lath-transfer arm 66, the lath transfer path ends when the forward-facing surface 44 contacts the lath-transfer abutting ridge 90. At this stage, the lath-pushing finger 62 returns to its rearward configuration, pivoting in the direction opposed to the first rotation direction 78, e.g., counter-clockwise in the non-limitative embodiment shown.

As shown in FIG. 9, when the first lath 22a is transferred onto the lath-supporting segment 92, the lath-supporting segment 92 extends substantially continuously with the transient lath store 68, i.e., without spacing inbetween, for a smooth and continuous lath transfer.

Furthermore, in the non-limitative embodiment shown, when the first lath 22a is transferred onto the lath-supporting segment 92, the lath-supporting segment 92 is slightly inclined downwardly with respect to the transient lath store 68. However, it is appreciated that, in another embodiment (not shown), the lath-supporting segment 92 can extend substantially parallel to and from the transient lath store 68 and a small gap can be provided between the transient lath store 68 and the lath-supporting segment 92.

Therefore, as the lath-pushing finger 62 pushes the first lath 22a towards the lath-supporting segment 92 of the rotatable lath-transfer arm 66 from the transient lath store 68, the lower-facing surface 48 of the lath 22 slides on the lath-supporting segment 92 until the lath 22 is entirely located on the rotatable lath-transfer arm 66, i.e., spaced-apart from and contactless with the transient lath store 68. As mentioned above, in the embodiment shown, the first lath 22a slides across the entire lath-supporting segment 92 of the rotatable lath-transfer arm 66 until the forward-facing surface 44 contacts the lath-transfer abutting ridge 90. In another embodiment, the displacement of the first lath 22a along the lath-supporting segment 92 can be stopped without contacting the lath-transfer abutting ridge 90.

In the embodiment shown, the rotatable lath-transfer arm 66 is rotatably mounted to the unit frame 58 and rotates in the first rotation direction 78, i.e., in the same direction as the lath-capturing finger 60 and the lath-pushing finger 62. However, it is appreciated that rotation/displacement of the lath-transfer arm 66, the lath-capturing finger 60 and the lath-pushing finger 62 is not compulsory. The rotatable lath-transfer arm 66 is connected to a lath-transfer arm shaft 94 mounted to the unit frame 58. The lath-transfer arm shaft 94 and the lath-transfer arm 66 mounted thereto rotate about a lath-transfer rotation axis 96. The lath-transfer arm shaft 94 is actuated by a motor operatively connected thereto. The motor can be an electric motor, like a servomotor, a DC motor, a stepper motor or a brushless motor. In another embodiment not shown, the actuator of the rotatable lath-transfer arm 66 can be a hydraulic system, a pneumatic system or another type of actuation mechanism.

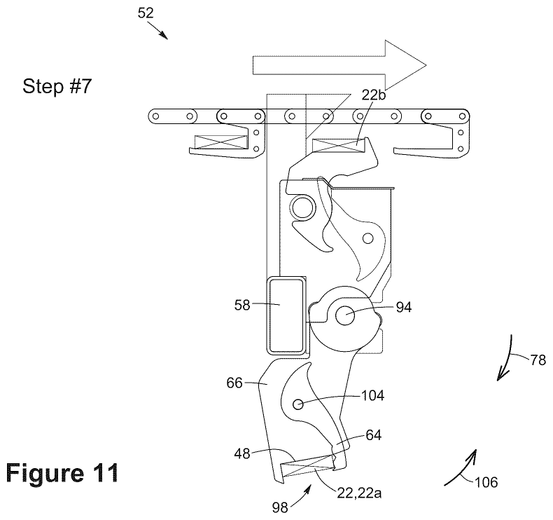

In the non-limitative embodiment shown, there is one lath-transfer arm shaft 94 for each set 51 of lath-transfer units 52 (See FIGS. 2, 3, and 11). The lath-transfer arm shaft 94 extends transversally between the lath-transfer units 52 of the set 51. The lath-transfer arm shaft 94 is rotatably mounted to the unit frames 58 of a respective set 51 of lath-transfer units 52. The lath-transfer arms 66 of the set 51 are secured to the lath-transfer arm shaft 94 and rotate simultaneously therewith. Therefore, the lath-transfer arms 66 of the set 51 are synchronized in their pivoting movement. They pivot between the lath-grasping configuration 80 (FIG. 10), wherein the lath 22 is transferred to the lath-transfer arm 66, to a lath-delivering configuration 98 (FIG. 11). The rotatable lath-transfer arm 66 rotates of an angle from 135 to 200 degrees from the lath-grasping configuration 80 to the lath-delivering configuration 98. Still referring to FIGS. 9 to 12, in combination with the lath-transfer abutting ridge 90, the lath-grasping finger 64 is used to grasp the first lath 22a, located on the lath-supporting segment 92 of the rotatable lath-transfer arm 66. The lath-grasping finger 64 is mounted to the rotatable lath-transfer arm 66. In the non-limitative embodiment shown, the lath-grasping finger 64 is rotatably mounted to the rotatable lath-transfer arm 66.

Once the first lath 22a is received on the lath-supporting segment 92 of the rotatable lath-transfer arm 66, the lath-grasping finger 64 and the rotatable lath-transfer arm 66 are configured in the lath-grasping configuration 80. More particularly, the lath-grasping finger 64 is moved towards the rearward-facing surface 88 in order to clasp the first lath 22a between the lath-transfer abutting ridge 90 of the rotatable lath-transfer arm 66 and the lath-grasping finger 64. Therefore, the first lath 22a is clasped with the forward-facing surface 44 of the first lath 22a abutting against the lath-transfer abutting ridge 90 and the rearward-facing surface 88 of the first lath 22a abutting against the lath-grasping finger 64 and, more particularly, a distal prehension end 100 of the lath-grasping finger 64.

In the embodiment shown, the lath-grasping finger 64 is rotatably mounted to the rotatable lath-transfer arm 66 and rotates in the first rotation direction 78 to clasp the lath 22, i.e., in the same direction as the lath-capturing finger 60 and the lath-pushing finger 62. The lath-grasping finger 64 is connected to a lath-grasping finger shaft 102 mounted to the rotatable lath-transfer arm 66. The lath-grasping finger shaft 102 rotates about a lath-grasping finger rotation axis 104. In the non-limitative embodiment shown, the lath-grasping finger rotation axis 104 and the lath-transfer rotation axis 96 are spaced-apart from one another. The lath-grasping finger shaft 102 is actuated by a motor operatively connected thereto. The motor can be an electric motor, like a servomotor, a DC motor, a stepper motor or a brushless motor. In another embodiment (not shown), the actuator of the lath-grasping finger 64 can be a hydraulic system, a pneumatic system or another type of actuation mechanism.

Even though the displacement of the lath-grasping finger 64 is embodied by a rotation movement, it is appreciated that, in an alternative embodiment, the displacement of the lath-grasping finger 64 can differ. For instance and without being limitative, in another embodiment (not shown), the lath-grasping finger 64 can move along a translation axis, therefore being displaced by translation instead of rotation. In still another embodiment, the lath-grasping finger 64 can be displaced along a trajectory that is a combination of a rotation and a translation.

FIG. 10 also shows that the lath-capturing finger 60 seizes a second lath 22b from the conveyor 32 at the lath-transferring position 37. More particularly, the second lath 22b is located on the supported by the lath-supporting segment 72 of the lath-capturing finger 60, which, in turn, in configured in the lath-capturing configuration 56.

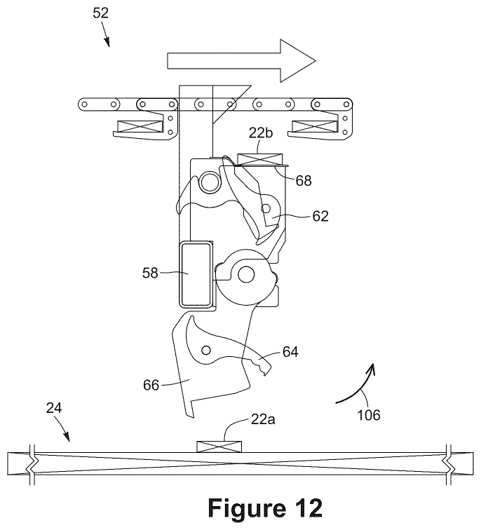

Referring more specifically to FIGS. 11 and 12, once the first lath 22a is grasped between the lath-grasping finger 64 and the lath-transfer abutting ridge 90 of the rotatable lath-transfer arm 66, the rotatable lath-transfer arm 66 rotates in the first rotation direction 78 until it reaches the lath-delivering configuration 98 (about 180 degrees in the non-limitative embodiment shown). During the rotation of the rotatable lath-transfer arm 66, the lath-grasping finger 64 does not rotate but firmly maintains the first lath 22a clamped.

As previously mentioned, the lath-grasping finger rotation axis 104 is excentric from the lath-transfer rotation axis 96. Amongst others, this eccentricity allows the rotation of the rotatable lath-transfer arm 66 to be compact and can reduce the risk of mechanical interference between the fingers 60, 62, 64 and lath-transfer arm 66.

Once the lath-transfer arm 66 is at the lath-delivering configuration 98, with the first lath 22a located above the lumber bundle 23, the lower-facing surface 48 of the first lath 22a is now a top-facing surface as the first lath 22a has made a 180-degree rotation from the lath-grasping configuration 80. To release the first lath 22a over the topmost tier 24 of the lumber bundle 23, the lath-grasping finger 64 rotates in a second rotation direction 106, opposite to the first rotation direction 78 (e.g. counter-clockwise in the non-limitative embodiment shown), to release the first lath 22a. Once released, the lath 22 falls on the lumber bundle 23 by the gravity (FIG. 12).

FIG. 12 also shows that the lath-capturing finger 60 has rotated in the first rotation direction 78 and released the second lath 22b onto the transient lath store 68, as detailed above for the first lath 22a. The lath-capturing finger 60 is configured in the lath-releasing configuration 57 with the lath-pushing finger 62 being configured in the rearward configuration, rearwardly of the second lath 22b.

Once the first lath 22a is released from the rotatable lath-transfer arm 66, as shown in FIG. 12, the rotatable lath-transfer arm 66 rotates in the second rotation direction 106 to return to the lath-grasping configuration 80, adjacent/juxtapose to the transient lath store 68. At this stage, a complete lath-transfer cycle has been performed for the first lath 22a: the lath-capturing finger 60, the lath-pushing finger 62, the rotatable lath-transfer arm 66, and the lath-grasping finger 64 have sequentially contacted the first lath 22a to transfer the first lath 22a from the conveyor assembly 26 to the lumber bundle 23 and have returned to their rearward configuration to begin a new lath-transfer cycle, as shown in FIG. 12, wherein a subsequent cycle has already begun for the second lath 22b.

Thus, as shown in FIGS. 10 to 12, there is shown that the lath-transfer unit 52 is capable of progressively processing more than one lath 22 simultaneously. This can be advantageous as the laths 22 can be transferred to the lumber bundle 23 quicker than if the lath-transfer unit 52 had to fully complete one lath-transfer cycle before starting a subsequent lath-transfer cycle. As seen in FIGS. 10 and 11, once that the first lath 22a is transferred to the rotatable lath-transfer arm 66 and grasped between the lath-grasping finger 64 and the lath-transfer abutting ridge 90, the lath-capturing finger 60 can capture a subsequent lath 22b, i.e. the second lath 22b, from the conveyor 32. This is possible since the geometrical configuration of the unit frame 58 allows the movement of the lath-capturing finger 60 and the rotatable lath-transfer arm 66 without interference. As seen in FIG. 12, the second lath 22b can be transferred to the transient lath store 68 by the lath-capturing finger 60 when the rotatable lath-transfer arm 66 has rotated in the first rotation direction 78 to the lath-delivering configuration 98. It is understood that other configurations of different fingers 60, 62, 64 and the lath-transfer arm 66 are possible in order to have a progression of multiple laths 22 simultaneously within a single lath-transfer unit 52.

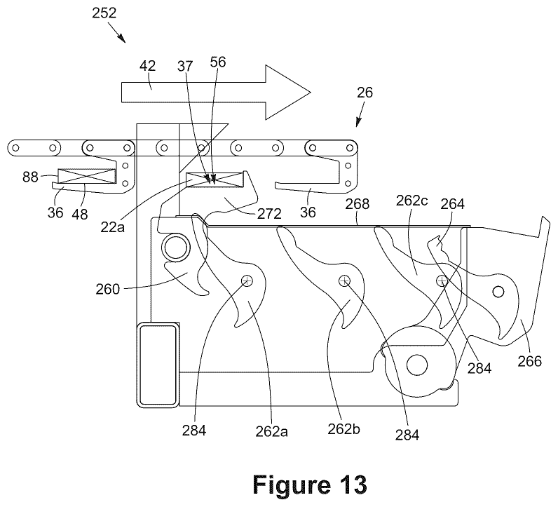

Referring to FIGS. 13 to 20, there is shown an alternative embodiment of the lath-transfer unit 52 wherein the features are numbered with reference numerals in the 200 series which correspond to the reference numerals of the previous embodiment. In comparison to the above-described embodiment, the transient lath store 268 is longer to contain multiple laths 22 simultaneously. In addition, the lath-transfer unit 252 includes a plurality of lath-pushing fingers 262 mounted side-by-side (spaced-apart along the longitudinal axis, which corresponding to the lath-conveying direction 42) to the unit frame 58. More specifically, in the non-limitative embodiment shown, the lath-transfer unit 252 includes three lath-pushing fingers 262a, 262b, 262c that sequentially push the laths 22 along the transient lath store 268. Each one of the lath-pushing fingers 262a, 262b, 262c is mounted to its own lath-pushing finger shaft 284, which extend parallel to one another and spaced-apart from one another. The three lath-pushing fingers 262a, 262b, 262c contacts the rearward-facing surface 88 of the lath 22 in order to slide sequentially the lower-facing surface 48 on the transient lath store 268.

The lath-capturing finger 260, the lath-pushing fingers 262a, 262b, 262c, the lath-grasping finger 264, and the rotatable lath-transfer arm 266 are actuated sequentially to progressively transfer the laths 22 from the conveyor assembly 26 to the lumber bundle (not shown) with a sequence that reduces the risk of interference between the different fingers 260, 262, 264, the lath-transfer arm 266 and the laths 22 moving through the lath-transfer unit 252.

In an embodiment, the lath-pushing fingers 262a, 262b, 262c can be offset along the transversal axis to avoid interference during rotation. It is appreciated that the number of lath-pushing fingers 262 can vary from the embodiment shown.

In FIG. 13, a first lath 22a, previously conveyed by a first lath-transfer lug 36 up to a respective lath-transferring position 37, has been captured by the lath-capturing finger 260. More particularly, the first lath 22a is located on and supported by the lath-supporting segment 272 of the lath-capturing finger 260, which, in turn, in configured in the lath-capturing configuration 56.

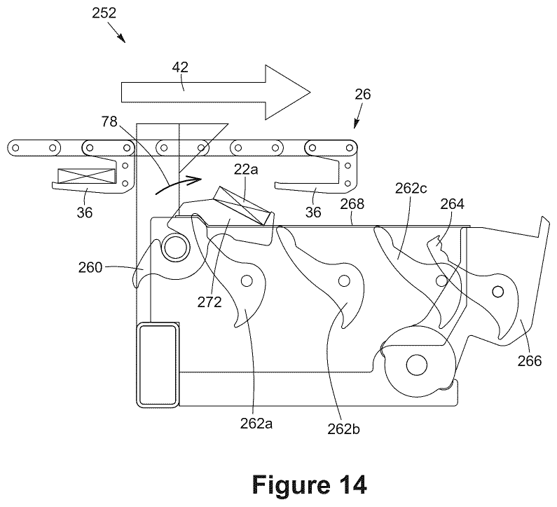

In FIG. 14, the lath-capturing finger 260, having the first lath 22a supported on its lath-supporting segment 272, is rotated in the first rotation direction 78, towards the transient lath store 268.

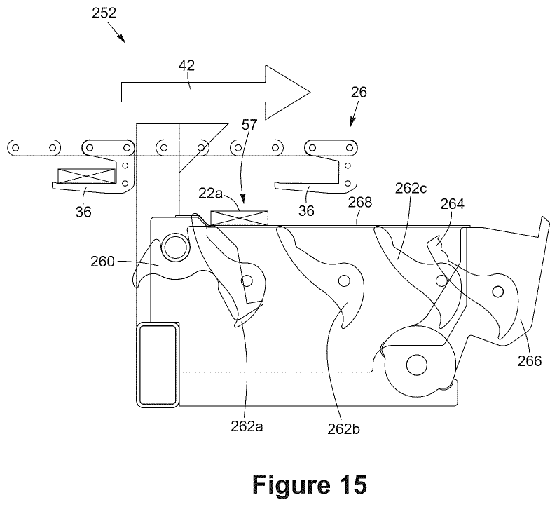

In FIG. 15, the lath-capturing finger 260 is configured in the lath-releasing configuration 57, located below the transient lath store 268. The first lath 22a has been released onto the transient lath store 268, in a proximal position, i.e. adjacent to the first lath-pushing finger 262a (i.e. the upstream lath-pushing finger), which is configured in the rearward configuration.

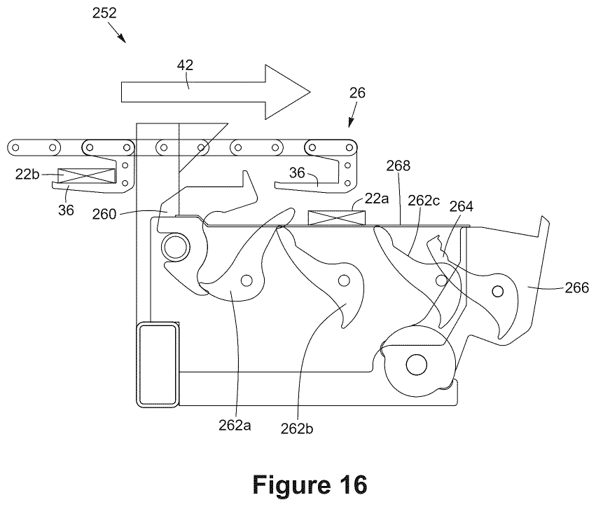

In FIG. 16, the first lath 22a has been pushed by the first lath-pushing finger 262a towards the second lath-pushing finger 262b. The first lath-pushing finger 262a, contacted the rearward-facing surface 88 of the first lath 22a in order to slide the lower-facing surface 48 thereof on the transient lath store 268. The second lath-pushing finger 262b is configured in the rearward configuration while the first lath-pushing finger 262a is configured in the forward configuration.

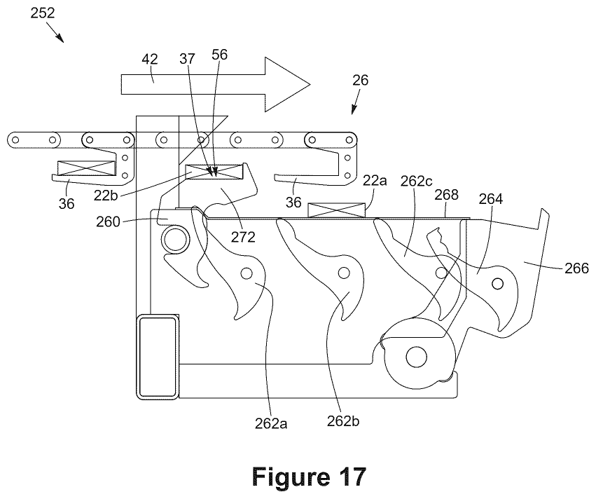

In FIG. 17, the first lath-pushing finger 262a has pivoted in the second rotation direction to return to its rearward configuration. A second lath 22b, conveyed by a second lath-transfer lug 36, has been captured by the lath-capturing finger 260. More particularly, the second lath 22b is located on the supported by the lath-supporting segment 272 of the lath-capturing finger 260, which, in turn, in configured in the lath-capturing configuration 56.

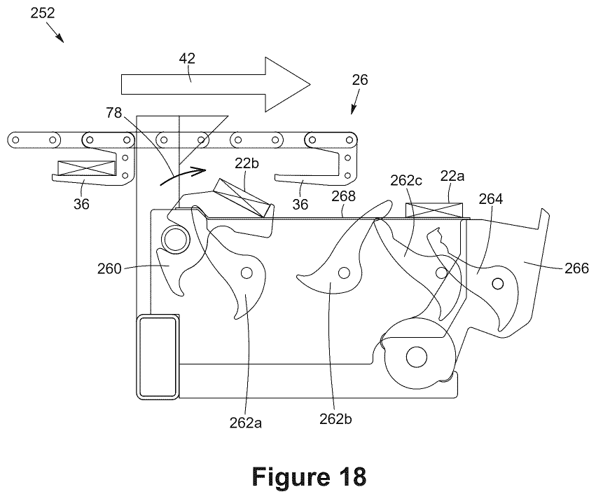

In FIG. 18, the second lath-pushing finger 262b has pivoted in the first rotation direction 78 to push the first lath 22a towards a third one 262c of the lath-pushing fingers and the second lath 22b is being transferred onto the transient lath store 268 by a rotation of the lath-capturing finger 260 in the first rotation direction 78.

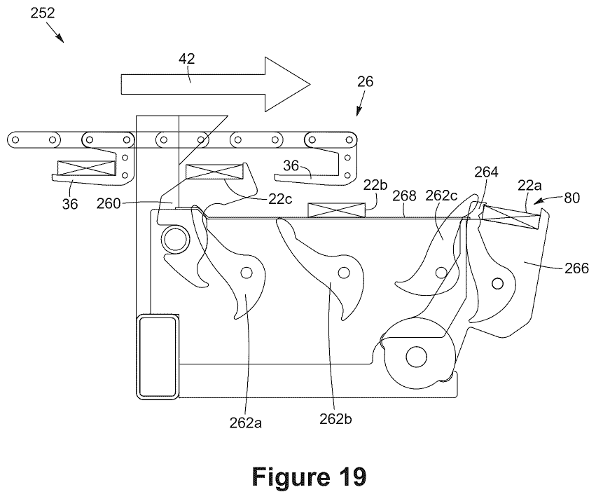

In FIG. 19, the first lath 22a has been pushed by the third lath-pushing fingers 262c (i.e. the downstream pushing finger in the particular embodiment including three pushing fingers 262) onto the rotatable lath-transfer arm 266 and clasped thereon with the lath-grasping finger 264. The rotatable lath-transfer arm 266 is configured in the lath-grasping configuration 80. The second lath 22b has been pushed by the first lath-pushing finger 262a towards the second lath-pushing finger 262b onto the transient lath store 268. A third lath 22c is conveyed by a subsequent lath-transfer lug 36 and being captured by the lath-capturing finger 260 at the lath-transferring position 37.

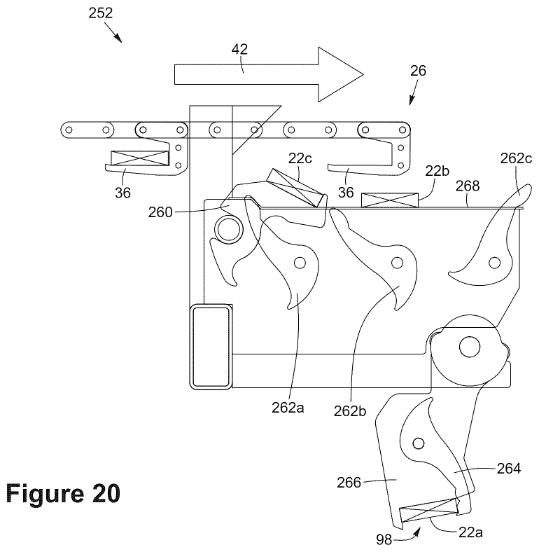

In FIG. 20, the rotatable lath-transfer arm 266, with the first lath 22a clamped therewith, has rotated to the lath-delivering configuration 98. The first lath 22a is ready for being released onto a top tier of a lumber bundle (not shown). The second lath 22b is still located on the transient lath store 268. The third lath 22c is transferred onto the transient lath store 268 by the lath-capturing finger 260.

Therefore, FIGS. 13 to 20 show that several laths 22a, 22b, 22c can be processed simultaneously by a single set 251 of lath-transfer units 252, thereby increasing the efficiency of the lath placer 220.

Referring back to FIG. 1, in an embodiment, the lath placer 20 further includes a monitoring system 108 and a control system 110 respectively to monitor the position of each lath 22 within the lath placer 20 and control actuation of the lath-capturing finger 60, the lath-pushing finger 62, the lath-grasping finger 64 and the rotatable lath-transfer arm 66. The monitoring system 108 includes sensors along a path of the laths 22. The sensors on the conveyor assembly 26 monitor the laths 22 located at the loading station 30 and the laths 22 carried by the lath-supporting lugs 36. In the lath-transfer assembly 28, the sensors monitor the position of all the laths 22 within the lath-transfer assembly 28, optionally, along with the position of at least one of the lath-capturing finger 60, the lath-pushing finger 62, the lath-grasping finger 64 and the rotatable lath-transfer arm 66. The control system 110 is responsible for preventing interference between the laths and the mechanical components as well as assuring a constant flow of the laths 22 through the lath placer 20 by selectively actuating the lath-capturing finger 60, the lath-pushing finger 62, the lath-grasping finger 64 and the rotatable lath-transfer arm 66.

In some embodiments, the monitoring system 108 can include one or more vision devices, such as cameras, adapted to visually detect, identify and/or track the position of the laths 22 or position sensors, such as encoders, photocells or proximity sensors, adapted to detect, identify and/or track the position of the laths and/or the mechanical components. In some embodiments, the monitoring system 108 can include different monitoring devices.

The monitoring system 108 and the control system 110 are above described in reference to the embodiment of FIGS. 1 to 12. However, it is appreciated that the description also applies to the embodiment of FIGS. 13 to 20, or any alternatives thereof.

In the above description, an embodiment is an example or implementation of the inventions. The various appearances of “one embodiment,” “an embodiment” or “some embodiments” do not necessarily all refer to the same embodiments.

Although various features of the invention may be described in the context of a single embodiment, the features may also be provided separately or in any suitable combination. Conversely, although the invention may be described herein in the context of separate embodiments for clarity, the invention may also be implemented in a single embodiment.

Reference in the specification to “some embodiments”, “an embodiment”, “one embodiment” or “other embodiments” means that a particular feature, structure, or characteristic described in connection with the embodiments is included in at least some embodiments, but not necessarily all embodiments, of the inventions.

It is to be understood that the phraseology and terminology employed herein is not to be construed as limiting and are for descriptive purpose only.

The principles and uses of the teachings of the present invention may be better understood with reference to the accompanying description, figures and examples.

It is to be understood that the details set forth herein do not construe a limitation to an application of the invention.

Furthermore, it is to be understood that the invention can be carried out or practiced in various ways and that the invention can be implemented in embodiments other than the ones outlined in the description above.

It is to be understood that the terms “including”, “comprising”, “consisting” and grammatical variants thereof do not preclude the addition of one or more components, features, steps, or integers or groups thereof and that the terms are to be construed as specifying components, features, steps or integers.

If the specification or claims refer to “an additional” element, that does not preclude there being more than one of the additional element.

It is to be understood that where the claims or specification refer to “a” or “an” element, such reference is not being construed that there is only one of that element.

It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks.

The term “method” may refer to manners, means, techniques and procedures for accomplishing a given task including, but not limited to, those manners, means, techniques and procedures either known to, or readily developed from known manners, means, techniques and procedures by practitioners of the art to which the invention belongs.

The descriptions, examples, methods and materials presented in the claims and the specification are not to be construed as limiting but rather as illustrative only.

Meanings of technical and scientific terms used herein are to be commonly understood as by one of ordinary skill in the art to which the invention belongs, unless otherwise defined.

It will be appreciated that the methods described herein may be performed in the described order, or in any suitable order.

Several alternative embodiments and examples have been described and illustrated herein. The embodiments of the invention described above are intended to be exemplary only. A person of ordinary skill in the art would appreciate the features of the individual embodiments, and the possible combinations and variations of the components. A person of ordinary skill in the art would further appreciate that any of the embodiments could be provided in any combination with the other embodiments disclosed herein. It is understood that the invention may be embodied in other specific forms without departing from the central characteristics thereof. The present examples and embodiments, therefore, are to be considered in all respects as illustrative and not restrictive, and the invention is not to be limited to the details given herein. Accordingly, while the specific embodiments have been illustrated and described, numerous modifications come to mind. The scope of the invention is therefore intended to be limited solely by the scope of the appended claims.

1. A lath placer configured to dispose a lath perpendicular to and over a row of lumbers, the lath placer comprising:
a conveyor assembly including at least one lath-supporting lug to move the lath seized at a lath pick-up position along a lath conveying direction; and
a lath-transfer assembly, adjacent to the conveyor assembly, and including at least one lath-transfer unit comprising:
a unit frame including a transient lath store;
a lath-capturing finger movable to capture the lath from a corresponding one of the at least one lath-supporting lug located at a lath-transferring position and release the lath on the transient lath store;
a lath-pushing finger movable to push the lath away from the transient lath store;
a rotatable lath-transfer arm including a lath-supporting segment configured to receive the lath transferred by the lath-pushing finger, the rotatable lath-transfer arm is rotatable between a lath-grasping configuration and a lath-delivering configuration; and
a lath-grasping finger movable to grasp the lath located on the lath-supporting segment of the rotatable lath-transfer arm at the lath-grasping configuration and to release the lath at the lath-delivering configuration.

2. The lath placer according to claim 1, wherein the lath-capturing finger is rotatably mounted to the unit frame and rotatable about a lath-capturing finger rotation axis, the lath-capturing finger rotating in a rotation direction corresponding to the lath conveying direction to transfer the lath from the lath-supporting lug to the transient lath store and the transient lath store is located below the corresponding one of the at least one lath-supporting lug at the lath-transferring position.

3. The lath placer according to claim 1, wherein the lath-capturing finger comprises a lath-supporting segment to support the lath during a transfer to the transient lath store and a lath-capturing abutting ridge extending upwardly from the lath-supporting segment, wherein the lath conveyed by the conveyor assembly abuts against the lath-capturing abutting ridge at a lath-capturing configuration and is transferred onto the lath-supporting segment of the lath-capturing finger.

4. The lath placer according to claim 3, wherein the lath-transfer assembly is located under the conveyor assembly, the conveyor assembly comprises a conveyor chain with a lower segment, and wherein the lath-transferring position is located on the lower segment of the conveyor chain and the lath-supporting segment of the lath-capturing finger is substantially aligned with or extends below a lower-facing surface of the lath conveyed by the conveyor assembly.

5. The lath placer according to claim 1, wherein the lath-pushing finger is rotatably mounted to the unit frame and rotatable about a lath-pushing rotation axis between a rearward configuration located behind the lath supported by the transient lath store and a forward configuration located behind the lath supported by the lath-supporting segment of the rotatable lath-transfer arm.

6. The lath placer according to claim 1, wherein the transient lath store extends horizontally and is located rearwardly of and extends continuously with the lath-supporting segment of the rotatable lath-transfer arm when the rotatable lath-transfer arm is configured in the lath-grasping configuration.

7. The lath placer according to claim 1, wherein the lath-grasping finger is rotatably mounted to the rotatable lath-transfer arm, is rotatable about a lath-grasping rotation axis, and is located below the transient lath store when the lath-pushing finger transfers the lath from the transient lath store to the lath-supporting segment of the rotatable lath-transfer arm, configured in the lath-grasping configuration.

8. The lath placer according to claim 1, wherein the lath-grasping finger comprises a prehension end contacting a rearward-facing surface of the lath located on the lath-supporting segment of the rotatable lath-transfer arm at the lath-grasping configuration and the rotatable lath-transfer arm comprises a lath-transfer abutting ridge contacting a forward facing surface of the lath located on the lath-supporting segment of the rotatable lath-transfer arm, the lath being clamped between the prehension end of the lath-grasping finger and the lath-transfer abutting ridge of the rotatable lath-transfer arm during rotation to the lath-delivering configuration.

9. The lath placer according to claim 1, wherein the lath-capturing finger, the lath-pushing finger, and the rotatable lath-transfer arm rotates in a same rotation direction to transfer the lath from one location to a subsequent location and the rotatable lath-transfer arm rotates of an angle of from 135 to 200 degrees from the lath-grasping configuration to the lath-delivering configuration.

10. The lath placer according to claim 1, wherein the lath-transfer assembly comprises a plurality of lath-transfer unit sets, each one of the sets including at least one of the lath-transfer unit, wherein each one of the sets comprises at least two of the lath-transfer unit, spaced-apart transversally from one another, and wherein the lath-capturing finger, the lath-pushing finger, the rotatable lath-transfer arm, and the lath-grasping finger of a respective one of the sets are synchronized, and wherein the lath is released on the row of lumbers.

11. A lath placer configured to dispose laths perpendicular and over a row of lumbers, the lath placer comprising:
a conveyor assembly including lath-supporting lugs to convey the laths seized at a lath pick-up position along a lath conveying direction; and
a lath-transfer assembly, adjacent to the conveyor assembly comprising:
a unit frame including a transient lath store;
a lath-capturing finger movable to capture the laths from the lath-supporting lugs when located at a lath-transferring position and release the captured laths on the transient lath store;
a plurality of lath-pushing fingers, each one of the lath-pushing fingers being movable to push away a respective one of the laths located at the transient lath store;
a rotatable lath-transfer arm including a lath-supporting segment configured to receive the respective one of the laths transferred by a respective one of lath-pushing fingers, the rotatable lath-transfer arm is rotatable between a lath-grasping configuration and a lath-delivering configuration; and
a lath-grasping finger movable to grasp the respective one of the laths located on the lath-supporting segment of the rotatable lath-transfer arm at the lath-grasping configuration and to release the respective one of the laths at the lath-delivering configuration.

12. The lath placer according to claim 11, wherein the lath-capturing finger is rotatably mounted to the unit frame and rotatable about a lath-capturing finger rotation axis, the lath-capturing finger rotating in a rotation direction corresponding to the lath conveying direction to transfer the laths from one of the lath-supporting lugs to the transient lath store and the transient lath store is located below the corresponding one of the lath-supporting lugs at the lath-transferring position.

13. The lath placer according to claim 11, wherein the lath-capturing finger comprises a lath-supporting segment to support the captured laths during a transfer to the transient lath store and a lath-capturing abutting ridge extending upwardly from the lath-supporting segment, wherein the laths conveyed by the conveyor assembly abut against the lath-capturing abutting ridge at the lath-transferring position and are transferred onto the lath-supporting segment of the lath-capturing finger.

14. The lath placer according to claim 11, wherein each of the plurality of lath-pushing fingers is rotatably mounted to the unit frame and rotatable about a respective of lath-pushing rotation axis to sequentially push the respective one of the laths between a rearward configuration located behind the respective one of the laths supported by the transient lath store and a forward configuration located behind the respective one of the laths supported by the lath-supporting segment of the rotatable lath-transfer arm.

15. The lath placer according to claim 11, wherein the transient lath store extends horizontally and is located rearwardly of and extends continuously with the lath-supporting segment of the rotatable lath-transfer arm when the rotatable lath-transfer arm is configured in the lath-grasping configuration.

16. The lath placer according to claim 11, wherein the lath-grasping finger is located below the transient lath store when a downstream one of the plurality of lath-pushing fingers transfers the respective one of the laths from the transient lath store to the lath-supporting segment of the rotatable lath-transfer arm, configured in the lath-grasping configuration.

17. The lath placer according to claim 11, wherein the lath-grasping finger comprises a prehension end contacting a rearward-facing surface of the respective one of the laths located on the lath-supporting segment of the rotatable lath-transfer arm at the lath-grasping configuration and the rotatable lath-transfer arm comprises a lath-transfer abutting ridge contacting a forward facing surface of the respective one of the laths located on the lath-supporting segment of the rotatable lath-transfer arm, the respective one of the laths being clamped between the prehension end of the lath-grasping finger and the lath-transfer abutting ridge of the rotatable lath-transfer arm during rotation to the lath-delivering configuration.

18. The lath placer according to claim 11, wherein the lath-transfer assembly comprises a plurality of lath-transfer unit sets, each one of the sets including at least one lath-transfer unit; and wherein the lath-capturing finger, the plurality of lath-pushing fingers, and the rotatable lath-transfer arm rotates in a same rotation direction to transfer the respective one of the laths from one location to a subsequent location.

19. A method to dispose a lath perpendicular to and over a row of lumbers with a lath placer, the method comprising:
conveying the lath along a conveying direction from a lath pick-up position to a lath-transfer assembly;
capturing the lath at a lath-transferring position and transferring the lath to a transient lath store;
pushing the lath located on the transient lath store onto a lath-supporting segment of a rotatable lath-transfer arm;
grasping the lath between the rotatable lath-transfer arm and a lath-grasping finger;
rotating the rotatable lath-transfer arm to transfer the lath to a lath-delivering configuration; and
releasing the lath at the lath-delivering configuration located above the row of lumbers.

20. The method according to claim 19, wherein the lath-transfer assembly transfers captures and release more than one lath simultaneously over the row of lumbers.
